(19) United States
(12) Patent Application Publication
(10) Pub. No.: US 2011/0120623 A1
(43) Pub. Date: May 26, 2011

(54) Method Of Obtaining Synthetic Structural Covering And Fixing Devices

(76) Inventor: Jose Guilherme Aceto, Sao Paulo (BR)

(21) Appl. No.: 12/673,034

(22) PCT Filed: Aug. 14, 2008
(86) PCT No.: PCT/BR2008/000249

§ 371 Date: Mar. 9, 2010

(30) Foreign Application Priority Data
Aug. 15, 2007 (BR) PI0703358 3

(51) Int. Cl. E06B 3/24; B32B 7/10

(52) U.S. Cl. 156/92; 156/109

(57) ABSTRACT

“METHOD OF OBTAINING SYNTHETIC STRUCTURAL COVERING AND FIXING DEVICES” is constituted of a method of obtaining synthetic structural covering and fixing devices (1), belonging to Civil Engineering field, constituted of a HTV (2) silicon rubber wrapping profile which involves the panel's (3) perimeter, such as, plate of glass, stone, metallic laminated plate, etc., and in case of double glass (4) the involvement reaches both internal side perimeters; the rubber coated panels are adhered by sticker (5), usually of silicon to the own base material (6) of the structure to be covered; associated to the anchorage by sticker (5), the panels are also supported by mechanical fasteners constituted of profiles and/or metallic accessories (7) screwed on the base material with redundant fixation; the said method allows the direct and simultaneous application, in a same plan of any nature compatible to the silicon in a same main structure which can be of any material, eliminating the intermediate metallic sash, usually of aluminum.

The present descriptive report refers to an invention patent for a method of obtaining structural covering with synthetic sashes and fixing devices, used for closings of constructions, facades or coverings, belonging to the Civil Engineering field which have been developed to replace the coverings and structural glazing of aluminum sashes, for synthetic sashes in HTV (High Temperature Vulcanized) silicon rubber profiles to obtain closing systems technically efficient, with redundant chemical and mechanical, ecological fixation and simplifying all stages to comply with the modern architecture tendencies.

### DISPLACEMENT HISTORY

Currently most of modern buildings which use glasses on the facades or coverings use “structural glazing” or glass glued with structural silicon.

An aluminum frame which receives a foam spacing ribbon which is self-adhesive delimiting the silicon joint to be applied (height and width) and the part's perimeter is manufactured in this system.

The glass is seated on the ribbon within the frame and the delimited space is totally filled with structural silicon. The joints are big and glue the glass to the frame with at least 6 mm thick and with certain width by the part's dimension and wind pressure exercised on it. The silicon cure time in a “structural glazing” conventional system varies from three to fourteen days according to the joint's dimension and to the silicon used.

The middle frames necessary to glue parts with silicon, and later be fastened to the main sash structure, require a work of design, production and handling with high difficulty, losses of materials and cost of time and money.

These are patent objects already granted to the petitioner:

PI-9803770-6, “Improvement Introduced to Aluminum Profile Structure Usable For Composition Of Box and Running Windows.

PI-9706290-1 “Improved Structures For Glass Facades Construction.”

PI-9702951-3, “Method Of Encapsulating of Silicon Glass For Use In Civil Construction and Glass Encapsulated in Obtained Silicon”.

PI-9800748-3, “Improved Cup-holder Structure and Assembly Method of a Cup-holder Structure.”

The inventor continued the studies on the glass encapsulating of glass in silicon, seeking the obtaining of an optimized solution which eliminates the metallic sashes.

New materials and compounds recently developed from extruded HTV (High Temperature Vulcanized) silicon rubbers have allowed a new evolution with an appropriate and superior performance formed by the glass or covering material, rubbers and by chemical gluing and mechanical fixation, forming a synthetic sash, with redundant fixation.

Any closing material, compatible to the gluing of structural silicon, can be applied by the “METHOD OF OBTAINING STRUCTURAL COVERING WITH SYNTHETIC SASHES AND FIXING DEVICES”, which is described below based on the enclosed drawings.

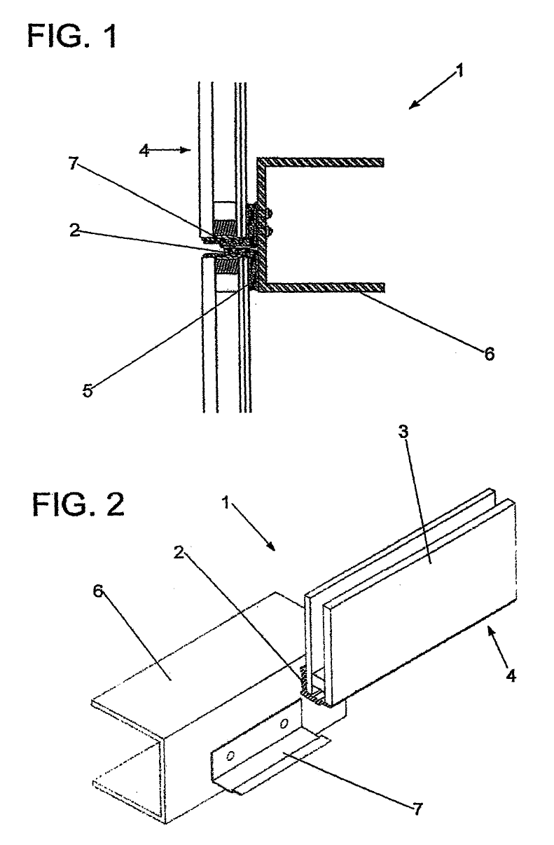

FIG. 1—Shows an insulating double glazed plate with HTV silicon rubber profile with the appropriate drawing to receive the structural gluing and mechanical fixing devices (7).

FIG. 2—Shows the insulating double glazed plate with HTV silicon rubber with the appropriate drawing to receive the structural gluing and mechanical fixing devices (7) fastened to the structure.

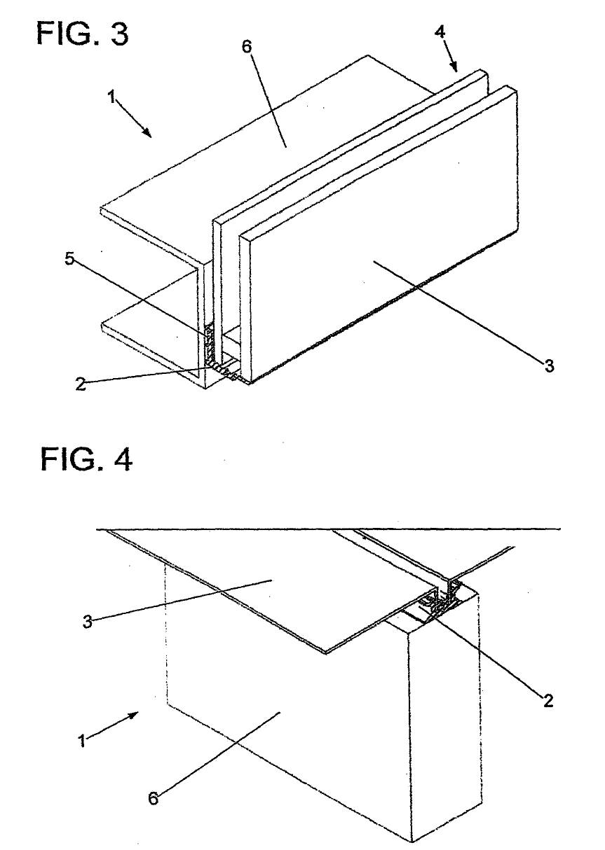

FIG. 3—Shows the insulating double glazed plate with HTV silicon rubber with the appropriate drawing to receive the structural gluing and mechanical fixing devices already applied to the structure.

FIG. 4—Shows another example of assembled metallic plate panel using the method of obtaining the synthetic structural covering and fixing devices.

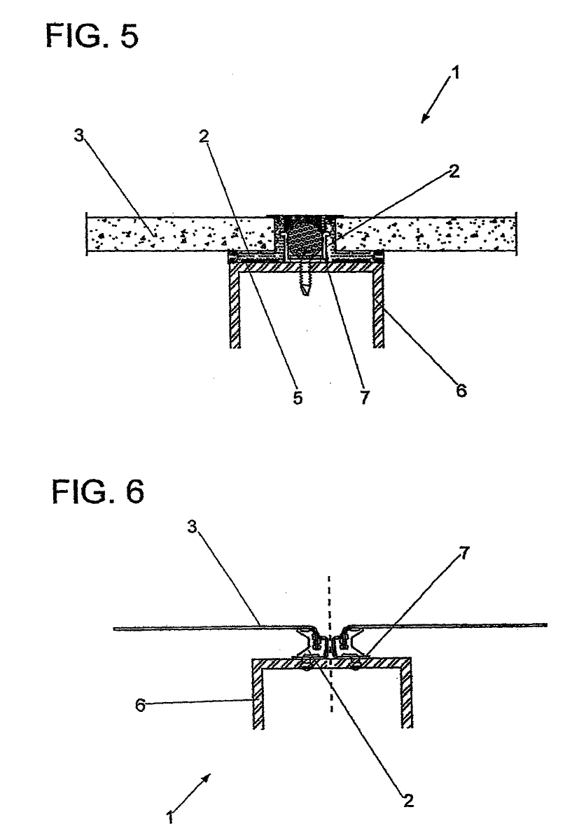

FIG. 5—Shows another example of assembled stone or cement panel using the method of obtaining synthetic structural covering and continuous and built-in fixing devices (7).

FIG. 6—Shows another example of assembled metallic place using the method of obtaining synthetic structural covering and claw-type fixing devices (7).

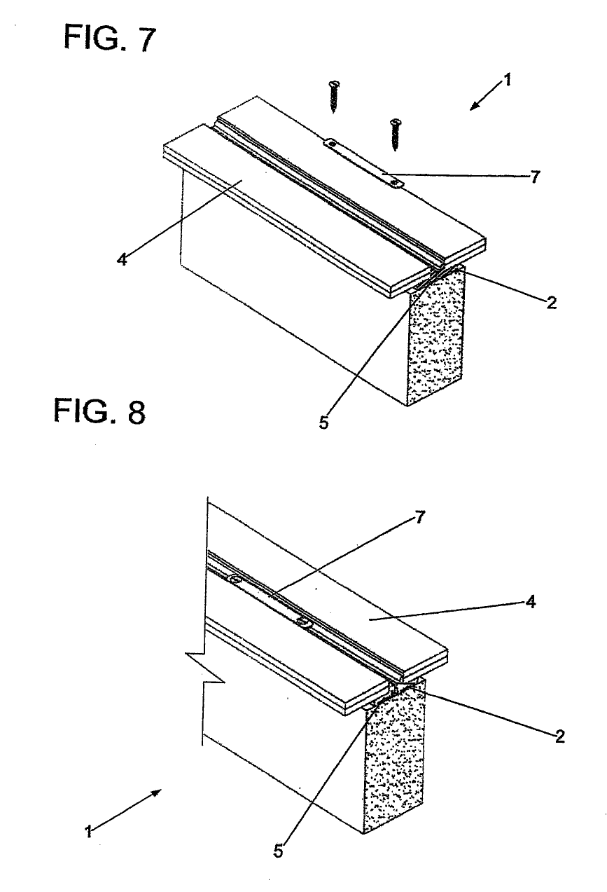

FIG. 7—Shows another example of assembled laminated glass using the method of obtaining synthetic structural covering and double-fastener fixing devices (7).

FIG. 8—Shows another example of assembled laminated glass panel using the method of obtaining synthetic structural covering and fixing devices (7) already applied on concrete or wood structure.

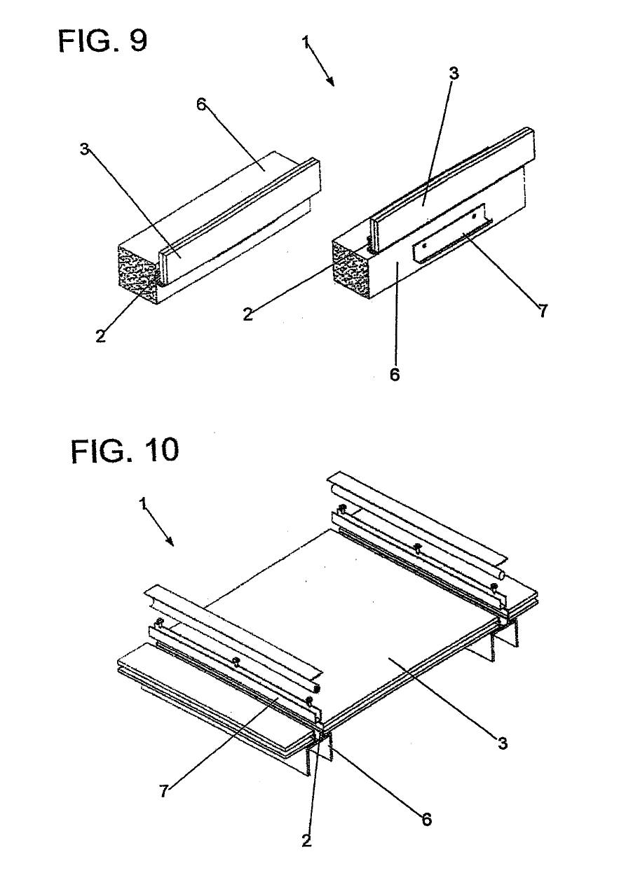

FIG. 9—Shows another example of assembled laminated glass panel using the method of obtaining synthetic structural covering and claw-type fixing devices (7) in stainless steel on wood structure.

FIG. 10—Shows another example of assembled insulating double glazed panel using the method of obtaining synthetic structural covering and continuous “U” profile-type fixing devices (7).

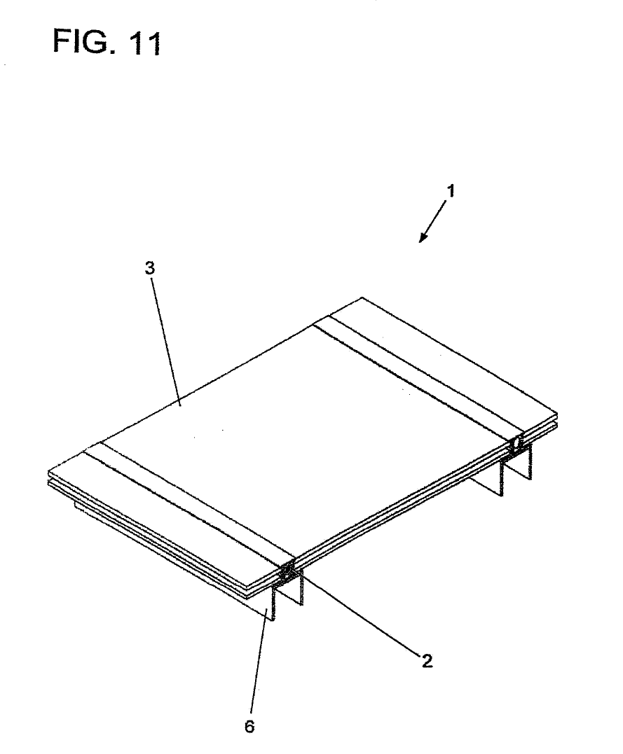

FIG. 11—Shows another example of assembled insulating double glazed panel using the method of obtaining synthetic structural covering and continuous “U” profile-type fixing devices (7) already applied.

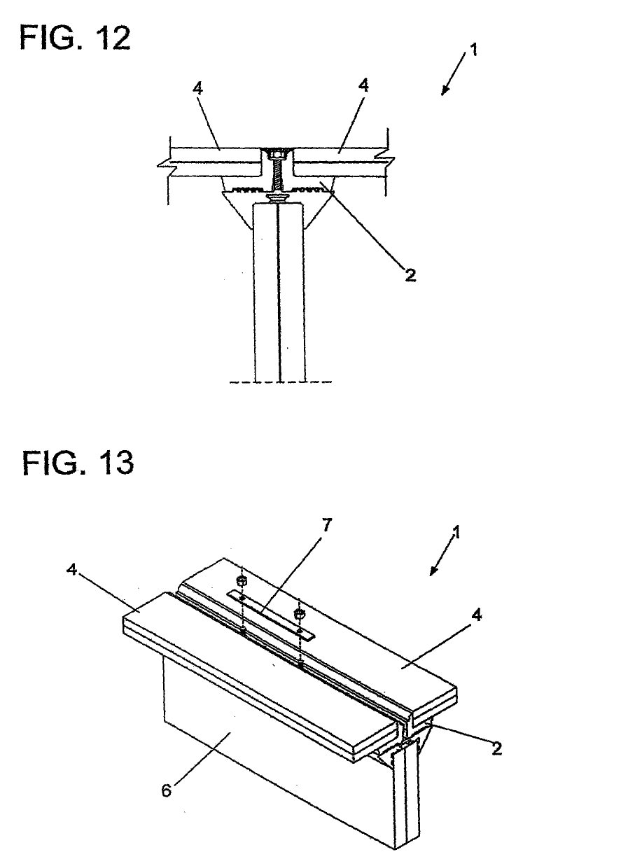

FIG. 12—Shows a cut assembled laminated glass panel using the method of obtaining synthetic structural covering and fixing devices (7) on also laminated glass structure.

FIG. 13—Shows another example, in perspective, of assembled laminated glass panels using the method of obtaining synthetic structural covering and fastener-type fixing devices (7), incorporated to the rubber profile of the also laminated glass structure.

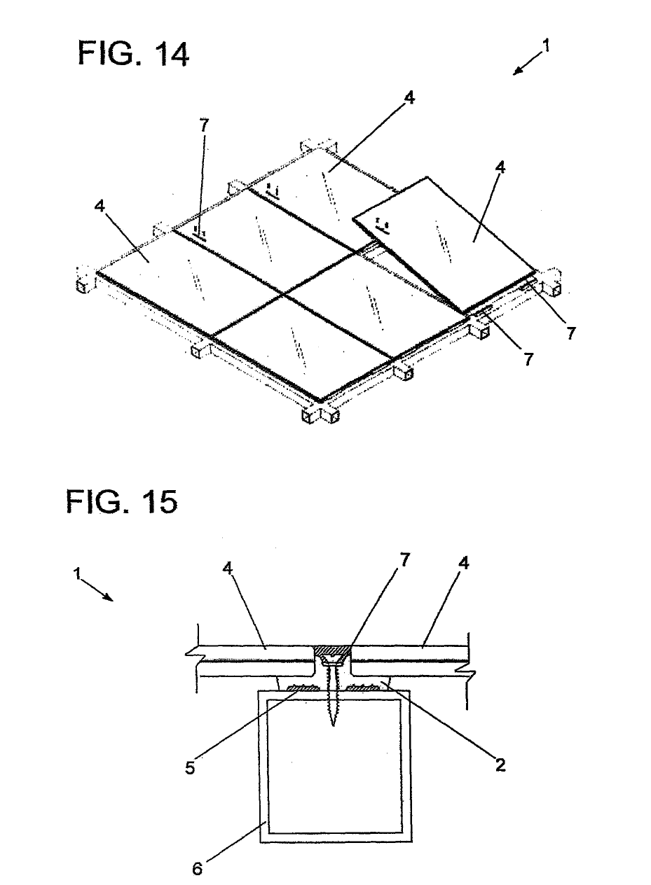

FIG. 14—Shows a perspective view of a set of panels assembled with the method of obtaining synthetic structural covering and double fastener-type and claw-type horizontal fixing devices (7) on structure of any material.

FIG. 15—Shows the laminated glass plate with the HTV silicon rubber profile with the appropriate drawing to receive the structural gluing and double fastener mechanical fixing devices (7).

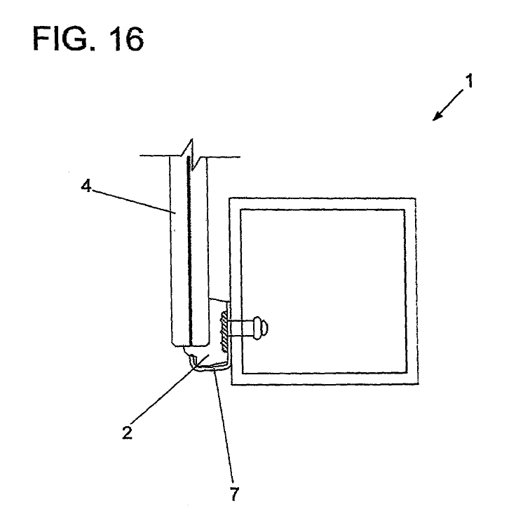

FIG. 16—Shows the laminated glass plate with the HTV silicon rubber profile with the appropriate drawing to receive structural gluing and claw-type mechanical fixing devices (7).

The built synthetic sashes are chemically glued and have continuous support profiles or claws for the discharge of the own weight, always mechanically fastened, forming a chemical and mechanical redundant fixation.

The HTV silicon profiles with compounds developed for high structural performance (superior to structural silicon) have the width and height dimensioned to safely obtain an elastic and durable connection (gluing the whole perimeter with a super dimensioned and mechanically fastened joint) to any type of closing or glazing of structures, which can be of any material, such as: steel, aluminum, concrete, wood, stones, glass, etc., forming a synthetic sash which eliminates the aluminum or other metal with great advantages and energy saving, materials and services.

The aluminum is the industrial product that most consumes electric power in its production being called solid energy, generating great dams for hydroelectric, thermo-electrical, nuclear, coal and other plants.

The HTV silicon rubber profiles is the only inorganic elastomer, counting on very high capacity to receive efforts, high and low temperatures, being inert to chemical attacks, bad weather and aging. It is the only rubber used in aircrafts, furnaces, high voltage isolation, etc.

Provides an elastic connection that, distributed the wind efforts, movement and dilation in a constant way what appropriately adds mechanical resistance of glass to the glazed set/structure.

We have acquired the control of mechanical properties, hardness, color and drawing of the HTV rubber profiles for the perfect coupling of the set obtained of synthetic structural covering and fixing devices to facades, coverings and revetments, counting on a super dimensioned width (from 1.5 to 3 times wider than a conventional joint) and appropriate height to the reception of efforts. The system comes pre-cured and firmly adhered to the covering or glass. The inorganic silica base generates compatibility and chemical welding.

The process can be used for application of all types of curved or flat materials: glasses, stainless steel, composed aluminum plates, galvanized steel plates, granites, some marbles and all cement or ceramic materials compatible to the structural silicon.

All method and systems of synthetic structural coverings besides the gluing by structural silicon count on mechanical fixing devices which incorporate the set and allow the perfect positioning during the cure period of the applied structural silicon and its redundant fixation. These claws, fasteners or profiles, fastened mechanically to the structures are incorporated to the system in a safe and invisible way, because they are covered by the sealing pasty silicon.

The HTV silicon profiles applied to the insulating double glasses still protect and increase significantly the durability of the internal chamber of dry air between glasses, avoiding steam to enter which could be condensed, since differently from the pasty silicon they are impermeable to gases.

The system can be applied to structures subject to vibration, movement and high dilation (the covering panel is located on a rubber mattress) with superior thermo-acoustic isolation. Due to the most slender layers of applied structural silicon saves money and a very much reduced cure time, could be handled after 24 up to 48 hours.

Production, handling and assembly are facilitated by the method that in spite of using the finest elastomer (HTV silicon), continues generating economy.

### INCORPORATION DETAILED DESCRIPTION

In compliance with the extent the figures above are illustrative in relation to the “METHOD OF OBTAINING SYNTHETIC STRUCTURAL COVERING AND FIXING DEVICES”, it idealizes a method for fixation of vitreous panels, or of any material in plate, although flat or curved, such as, stone plate, metallic laminated plate, cements, ceramic etc., in constructions in general, called method of obtaining synthetic structural covering and fixing devices (1), constituted of a wrapping profile of HTV (2) silicon rubber which involves the panel perimeter (3), such as, plate of glass, stone, metallic laminated plate, etc., and in case of double glass (4) the involvement reaches the whole internal lateral perimeter, in order to keep it isolated from humidity and internal condensation.

The rubber-coated panels are adhered by sticker (5), usually of silicon to the own base material (6) of the structure to be covered, as concrete or any nature material frame.

Associated to the anchorage by sticker (5), the panels are also supported by mechanical fasteners constituted by profiles and metallic accessories (7) screwed in the base material, keeping the wrapping profile of HTV (2) silicon rubber intermixed in relation to the panel (3) with redundant fixation.

The “METHOD OF OBTAINING SYNTHETIC STRUCTURAL COVERING AND FIXING DEVICES” allows the simultaneous application, in a same plan, of any material compatible material to the silicon in a same main structure that can be of any material, eliminating the intermediate metallic sash, usually of aluminum.

1. “METHOD OF OBTAINING SYNTHETIC STRUCTURAL COVERING AND FIXING DEVICES”, is characterized by a method of obtaining synthetic structural covering and fixing devices (1), constituted of a HTV (2) silicon wrapping profile which involves the panel perimeter (3), such as, plate of glass, stone, metallic laminated plate, etc., and in case of double glass (4) the involvement reaches the whole internal side perimeter, in order to keep it isolated from humidity and internal condensation; the rubber coated panels are adhered by sticker (5), usually of silicon to the own base material (6) of the structure to be covered, as concrete or any nature material frame.

2. “METHOD OF OBTAINING SYNTHETIC STRUCTURAL COVERING AND FIXING DEVICES”, according to claim 1, is characterized by the panels in general to be supported by mechanical fasteners, besides the fixation by sticker, which are constituted of profiles and/or metallic accessories (7) screwed on the base material, keeping the wrapping profile of HTV (2) silicon rubber intermixed in relation to the panel (3) with redundant fixation.

3. “METHOD OF OBTAINING SYNTHETIC STRUCTURAL COVERING AND FIXING DEVICES”, according to claim 1, is characterized by allowing the direct and simultaneous application, in a same plan, of any material compatible to the silicon in a same main structure which can be of any material, eliminating the intermediate and necessary metallic sash, usually in aluminum.
